(19) United States
(12) Patent Application Publication
(10) Pub. No.: US 2016/0019568 A1
(43) Pub. Date: Jan. 21, 2016

(54) ColorStream Inventory Management System and Methodology

(71) Applicant: Gennady BATRAKOV, Santa Clara, CA (US)

(72) Inventor: Gennady BATRAKOV, Santa Clara, CA (US)

(21) Appl. No.: 14/801,796

(22) Filed: Jul. 16, 2015

Related U.S. Application Data
(60) Provisional application No. 62/025,487, filed on Jul. 16, 2014.

(51) Int. Cl. G06Q 30/02; G06Q 10/08

(52) U.S. Cl. CPC G06Q 30/0202; G06Q 10/0875

(57) ABSTRACT

An Inventory Management system and methodology employing a BASE association algorithm in the assessment of graphical images for an Inventory (or Safety Stock/Forecast/Supply and/or Purchase Order) management and engaging procedure designed for systematic calculation of inventory adjustments based on graphical components interpretation and user defined rules. Instead of working with underlying numbers, the disclosed system and methodology works with associative numbers assigned to each component in every time bucket of a graphical chart in reference to its distinct BASE or calculated RUNRATE. Explicit colors are assigned to each component of the chart and color recognition may be used in establishing the associations by measuring and comparing the component levels in each defined area of the chart. Optionally, straight calculation can be used to determine the associative levels of the components. Levels for every component are expressed in units of an established BASE in every time frame bucket of the chart and will provide a foundation for computation of recommended forecast adjustments. To address active supply/forecast management and to control inventory levels the following elements must be inspected and evaluated daily: current inventory and forecast (future open orders), Shipping history and current Backlog (hard orders).

### FIELD OF THE INVENTION

The present invention relates generally to methods and systems for managing inventory and more particularly to an Inventory Management system and methodology for producing calculated recommendations for forecast adjustments and/or future order signals (or Safety Stock/Forecast/Supply and/or Purchase Order) and visually displaying these RECOMMENDATIONS for critical Customer review and approval with utilization of a Business Intelligence system of snapshots delivery.

### BACKGROUND OF THE INVENTION

Today many companies are experiencing well-known issues with respect to the use of existing forecasting and budgeting processes and systems used to keep their inventories at optimum levels and allow quick response to demand fluctuations. These issues relate to:
Frequency and Timeliness,
Flexibility and accuracy, and
Transparency and Access to Information.

All too often, the available end-to-end processes take too long to implement. In addition, due to the ever increasing complexities of Supply Chain business operations, Quarterly forecasts typically take at least two-to-five weeks to finalize, and as a consequence, budgets are often not finalized until well into the actual year to which they apply. Similarly, the time required to produce each iteration of a forecast or budget is usually too long, frequently taking days and sometimes weeks. In today's environment, the impact of any change to the financials needs to be known and understood within a day, or even an hour in some instances. Companies need to be able to understand and respond quickly to the impact of rapid changes affecting their business. Yet most organizations fail to forecast the financial impact of these changes fast enough. This is where modern Business Intelligence (BI) platforms offer excellent data discovery capabilities and are allowing businesses implementing them to move into the new territory of using Dashboards as aides for understanding their data and correspondingly making better business decisions.

BI Dashboards provide a style of reporting that graphically depicts performance metrics and enable a user to publish multi-object, linked reports and parameters with intuitive and interactive displays. In addition, dashboards often employ visualization components such as gauges, sliders, checkboxes and maps, and often show actual values of measures compared to goals or target values.

There are numerous BI platforms on the market today offering data discovery and such tools are undeniably providing huge advantages over older systems. It is now well understood that data visualization, when executed properly, has major advantages compared to the simple manipulation of raw data. A particularly significant advantage is that raw data taken from multiple sources, indexes, calculations, formulas, etc., can be condensed into a dynamic single dashboard. And such dashboard can simultaneously tell the history of the company's data (past), the current state of the company's business (present), and what the company can reasonably expect to occur (future) if no changes are made. This is to say that a well-designed dashboard will enable a user to interpret and gain meaningful understanding of his company's data at a glance.

It almost goes without saying that having timely, actionable information is a major asset in business today in that it provides a decision maker with the ability to quickly convert raw data into easily understandable visual elements, and thus make better decisions critical to the success of h company.

Well built Dashboards can also be used for analytical exploration and often allow the user to find gaps and uncover issues using data mining processes.

Cognitive research—studies examining how the human brain processes information—has demonstrated that the ability to visualize a number of interrelated information sources together, empowers the viewer to more easily and more clearly grasp the significance and overall meaning of an information set with greater accuracy. In business in particular, the most important view for every company, no matter how large or small is demand visibility with the ability to make timely inventory adjustments. Many companies have hundreds or thousands, or even tens of thousands of parts identified by SKU codes (or other parts codes) for which they would love to have individual Dashboards not only capture the inventory status, but also provide suggestions for improvement or corrective action. However, it is nearly impossible to do such low level analysis for so many items on a daily basis without computerized intervention. Based on this fact, in today's world, forecast validations and predictions are normally produced by complex mathematical algorithms which drive mountains of numbers and calculations.

While current systems are time and resource consuming, they are often also not very trustworthy; and it is thus difficult to rely blindly and entirely on a system that provides forecast numbers out of calculations made without proper validation because errors can be costly. And the negative impact can be significant, leading to a lack of confidence in both the numbers and the ability to deliver.

A forecast is a prediction, projection, or estimate of some future activity, event, or occurrence. Managing forecast numbers actively and precisely provides a good basis for lean inventory execution and control

In accordance with the present invention an Inventory Management system and methodology is provided employing a BASE association algorithm in the assessment of graphical images for an Inventory (or Safety Stock/Forecast/Supply and/or Purchase Order) management and engaging procedure designed for systematic calculation of inventory adjustments based on graphical components interpretation and user defined rules.

Instead of working with underlying numbers, the present invention works with associative numbers assigned to each component in every time bucket of a graphical chart in reference to its distinct BASE or calculated RUNRATE. Explicit colors are assigned to each component of the chart and color recognition may be used in establishing the associations by measuring and comparing the component levels in each defined area of the chart. Optionally, straight calculation can be used to determine the associative levels of the components.

Levels for every component are expressed in units of an established BASE in every time frame bucket of the chart and provide a foundation for computation of recommended forecast adjustments.

To address active supply/forecast management and to control inventory levels the following elements must be inspected and evaluated daily: current inventory and forecast (future open orders), Shipping history and current Backlog (hard orders). By using the disclosed automated process of future inventory corrections in the form of recommended adjustments—i.e. RECOMMENDATIONS, a system User (Customer) can control its outcome by employing configuration controls, visualizing its output on very detailed levels in the form of snapshots and have a final semi-automated approval step with override (Modify) capability.

Used in combination with a Business Intelligence methodology platform, recorded collections of graphical images which represent the current state of various inventory levels with historical and future outlook, and with visualization of recommended adjustments, the present system and method offer unlimited possibilities for rapid response by promoting confidence in its output and immediate correction mechanism.

The present invention can be easily adapted to work as a supplemental component complimenting any existing customer inventory management system. Working together with the DASHBOARDSTREAM system and methodology for example, the present invention is a natural extension of the DashboardStreaming process, and takes it to the next level to not only provide calculated recommendations to forecast changes, but also visualizes its recommendations through a proprietary dynamic snapshot management website personal page.

The present invention thus fulfills Customer needs to maintain certain levels of orders, discover gaps in supply more accurately, and accomplish innately responsible supply management with pre-defined configurations and controls provided directly to the Customer.

The present invention can also be self-trained by employing the learning method of User (Customer) elected choices in FORCASTING MODE and BASE TYPE selections.

The present invention can employ a single specific Master Template with specific aligned views of multiple feeds and is easily adaptable to any business of any size.

The present invention maintains minimal points of interaction with other systems and uses calculated corrections (i.e.—“RECOMMENDED FORECASTs”) as a final output at the end of the process run.

The present invention thus bridges the gap to allow small businesses to access and benefit from business intelligence data discovery services without owning and maintaining an expensive BI system.

These and other objectives and advantages of the present invention will no doubt become apparent to those skilled in the art after a reading of the following disclosure which makes reference to the several figures of the Drawing.

### IN THE DRAWING

This patent or application file contains at least one drawing executed in color. Copies of this patent or patent application publication, with color drawing(s), will be provided by the Office upon request and payment of the necessary fee. The several figures of the Drawing are included herein below along with a detailed description of each figure.

FIG. 1 is a block diagram schematically illustrating a COLORSTREAM Inventory Management System incorporated in a DASHBOARDSTREAM data management System in accordance with an embodiment of the present invention;

FIG. 2 is a block diagram schematically illustrating the Analytical Component of the embodiment of FIG. 1;

FIG. 3 is a block diagram schematically illustrating the Interface and Approval Components of the embodiment of FIG. 1;

FIG. 4 is a pictorial view illustrating the main Graphical Template used in an embodiment of the present invention;

FIG. 5 is a pictorial view illustrating a Master Template used in an embodiment of the present invention;

FIG. 6 is a chart illustrating an example of the Minimum required data feeds for an embodiment of the present invention;

FIGS. 7-11 are pictorial views illustrating other Master Templates used in an embodiment of the present invention;

FIG. 12 is an illustration of a Control Chart used by the Configuration Manager in an embodiment of the present invention;

FIG. 13 is an illustration of a BASE/RUNRATE Construction Chart in an embodiment of the present invention;

FIGS. 14-19 are examples of BASE Construction applications in an embodiment of the present invention;

FIG. 20 is a COLORSTREAM Inventory Management graph illustrating the DEFAULT MODE for RECOMMENDED forecast calculations with NET FORECAST view in an embodiment of the present invention;

FIG. 21 is a COLORSTREAM Inventory Management graph illustrating the DEFAULT MODE for RECOMMENDED forecast calculation with GROSS FORECAST view in an embodiment of the present invention;

FIG. 22 is another example of a COLORSTREAM Inventory Management graph illustrating the DEFAULT MODE in an embodiment of the present invention;

FIG. 23 is a COLORSTREAM Inventory Management graph illustrating the DEFAULT MODE as in FIG. 22 but with backlog values in an embodiment of the present invention;

FIG. 24 is an example of DASHBOARDSTREAM pre-sorted Snapshot Thumbnails of COLORSTREAM graphs as viewed in a web page of an embodiment of the present invention; and

FIG. 25 is a DASHBOARDSTREAM Example of Snapshot Thumbnails of COLORSTREAM graphs with Approval in an embodiment of the present invention;

### DETAILED DESCRIPTION OF THE INVENTION

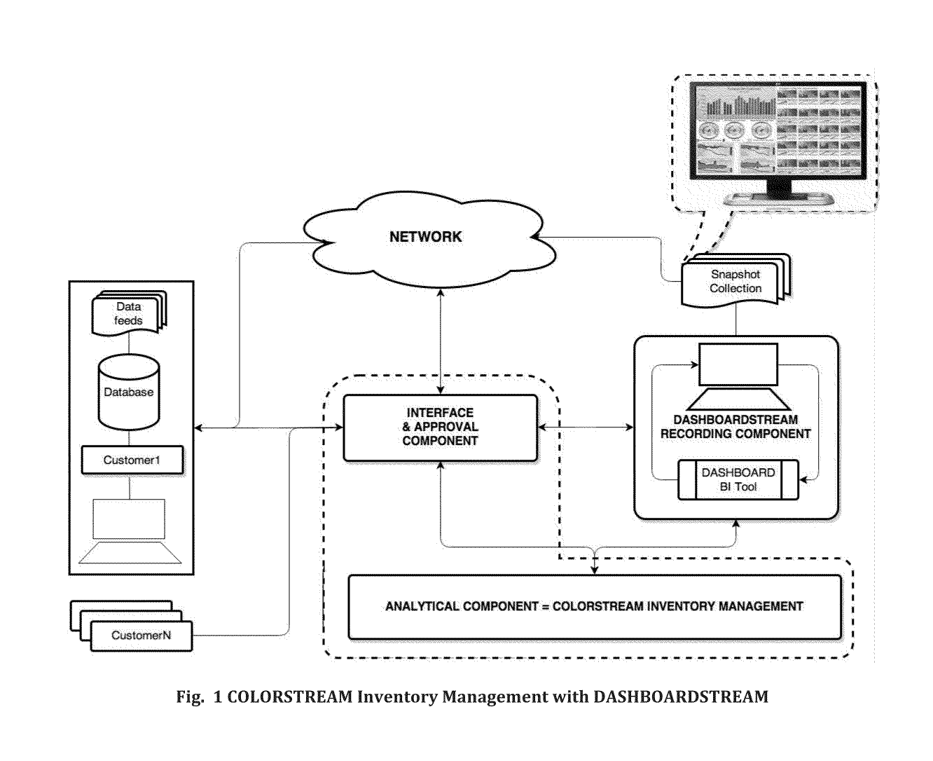

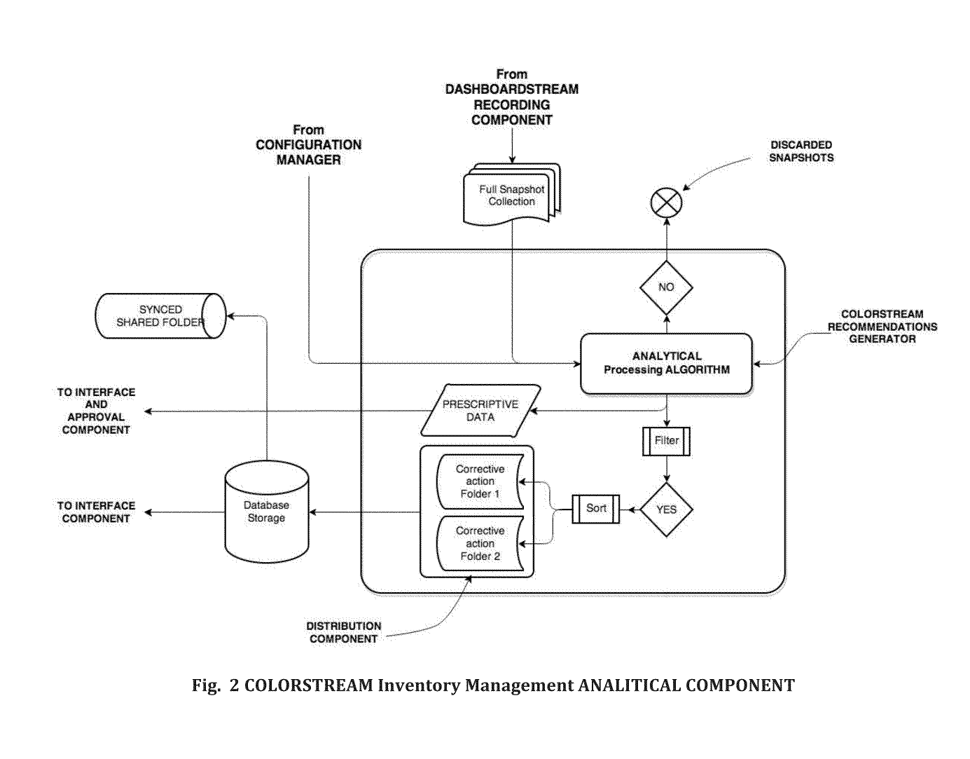

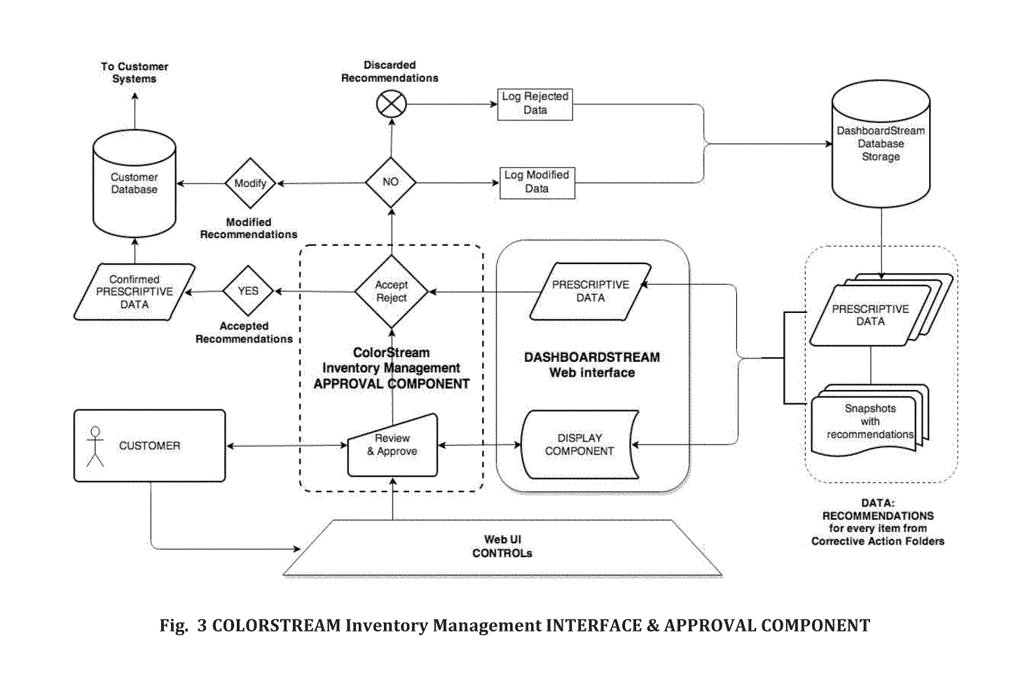

Referring now to FIG. 1 of the Drawing which generally illustrates how the COLORSTREAM SYSTEM and methodology works in conjunction with the DASHBOARDSTREAM system disclosed in my co-pending U.S. patent application Ser. No. 14/738,883 filed Jun. 13, 2015, and entitled “A network based business intelligence data gathering and presentation system and method for assessing, screening, storing and distributing predictive and prescriptive analysis of remote customer business data and returning the processed data in a customer selected dashboard snapshot presentation format for evaluation, execution and corrective action”, and which is hereby incorporated by reference.

The embodiments of the present invention described herein relate to a dashboard information presentation and data management system that will facilitate participation of non-technical users in receiving and evaluating business data and management information provided in the form of snapshots and prescriptive analysis utilizing a Business Intelligence dashboard displayed on a website remotely accessible by a subscribed Customer of the service.

The embodiments involve creation of specific dashboard graphs based on a running calculation of detailed levels of every part number or other item identifier of business product or other data selected by a Customer for analysis. The embodiments further involve applying a normalized BASE approach in analysis utilizing an approval mechanism display on a User Interface delivering visualization of the graphs and Recommendations generated by a service provider implemented using the DASHBOARDSTREAM System described in detail in my above identified co-pending U.S. patent application.

The COLORSTREAM Inventory Management (CsIM) methodology is based on a set of analyses and calculations applied using color differentiation on explicit parts of graphical image snapshots.

The image snapshots are exclusively constructed for this method and are precise in their layouts.

In most product orientated companies there are a few factors that are always available from which one can obtain a good understanding of the business status and condition. These factors include:
a) Shipments (historical data);
b) Backlog (Open orders);
c) Inventory (FGI—finished goods); and
d) Forecast (Future open orders).

In utilizing data related to these factors, the COLORSTREAM Layout must always remain fixed to the same time frame window for a given application. For example:
CURRENT MONTH “+” and “−” same time periods depending on individual business situations.
In an exemplary scenario the following will be used:
   “Current Month −5 preceding months” to “Current Month +5 following Months”.

Another optional layout can be used in weekly buckets with the same condition: e.g;
CURRENT WEEK “+” and “−” the same time period depending on individual business situations and preferences.

The following common elements are generally available and are normally used as graph dimensions:
a) Shipments. If possible they are represented in two ways:
   1) POS or any historical data (POS=“Point of Sale”, or sales directly to the customer); or
   2) Shipments to Distribution (or Store).
b) Backlog (current open orders) possibly represented in two ways:
   1) By Customer Request Date (CRD); or
   2) By Customer Scheduled Date (CSD).
c) Inventory (FGI—finished goods); and
d) Forecasts (Future open orders)

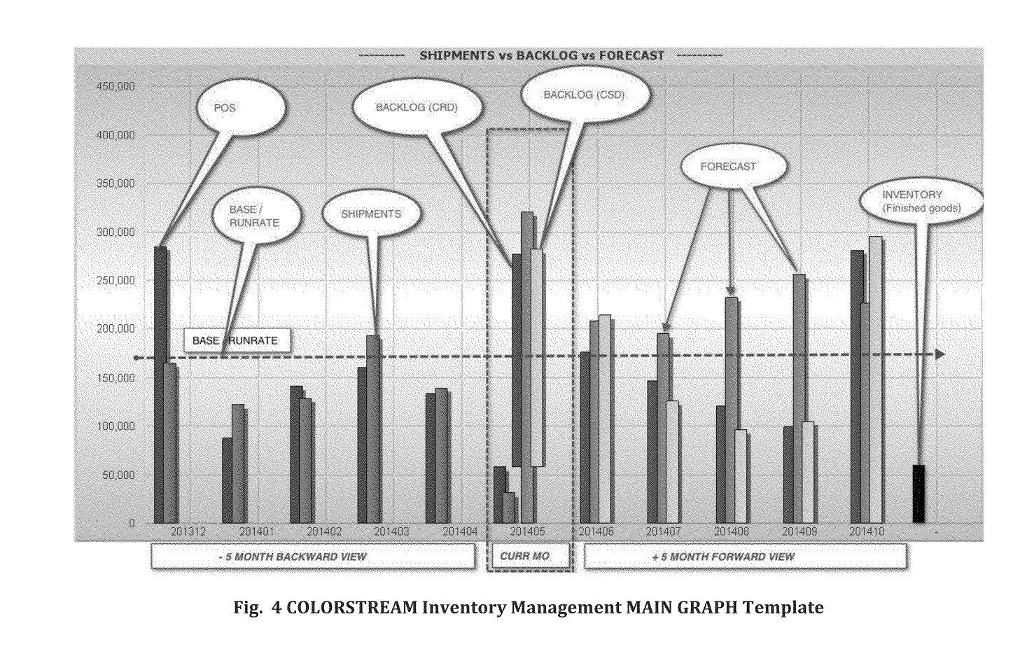

In accordance with the COLORSTREAM Inventory Management methodology, the MASTER TEMPLATE represents sales and inventory of a single product (item), and is as illustrated in FIG. 4 wherein the Current Month is shown in the middle of the graft; e.g., designated by Year “2014” and Month “05” (represented by “201405”). In this example:
the light blue bars represent—Shipments month-to-date-;—
the red bars represent—Backlog by Customer requested date (CRD)—; and
the yellow bars represent—Backlog by Customer scheduled date (CSD)-.

To the left of the Current month, historical data is presented as POS or Shipments for that specific item:

To the right side of the Current month, projected future data is presented (FORECAST):

In this case, BACKLOG is depicted in red (CRD) and yellow (CSD) vertical bar layouts monthly for the next 5 months; and
the green bars represent—FORECASTs for each of the next 5 months.

On the right side of the 5 month forward view, a vertical black bar is used to depict Finished Goods Inventory level (FGI).

The horizontal purple dashed line extending from the left side to the right side of the diagram represents the calculated RUNRATE for the given item and serves as a calculated BASE line.

In this view of the MASTER TEMPLATE there are two kinds of shipments respectively shown in darker and lighter blue colors:
the dark blue colored bars represent POS Shipments (directly to the customer); and
the lighter blue colored bars represent Shipments to the Distributor or to the Store receiving the shipments.

Both types of shipment indicators assist in the further understanding of inventory flow, and provide clues as to past overstock and shortage situations.

Additional information can also be gained in understanding and comparison of the two kinds of shipment data during the different time frames, especially during or close to the current month.

For example; if shipments to a distributor (light blue in the illustrated current month bars) are greater in total value in comparison to direct sales,—(POS—point of Sale, or sales directly to the customer as represented by the dark blue bar)—it means there is an accumulation of inventory taking place at the distributor (or store) receiving the product.

Vise versa—if the direct Sales (dark blue) volume is higher than the shipments to the distributor or store, it means that the store (distributor) inventories of its safety stock are being depleted.

For simplicity in this diagram, only one type of shipment data is presented.

The Initial state of the COLORSTREAM Inventory Management methodology uses the following default settings in the CONFIGURATION MANAGER of the DASHBOARDSTREAM system described above:
a) STANDARD BASE;
b) DEFAULT FORECAST MODE—NEUTRAL;
c) TREND=“N”; and
d) SEASONALITY=“N”.

Advanced mode settings will be available to the Customer in the following ways:
1).'Using the CONFIGURATION MANAGER with specific settings for each parameter; and
2). Utilizing a self-learning algorithm (for COLORSTREAM Inventory Management) where the customer will be provided with a multiple set of scenarios and will have to choose its desired forecast adjustments using the web UI.

The COLORSTREAM System will attempt to match advanced settings to the Customer chosen settings input using sliders to assign its own forecast adjustments based on each scenario provided.

Scenarios for self-learning algorithms will be chosen in such way that each will represent specific issues, situations and/or trends, and after a user/customer aligns each scenario with its own expected behavior, the System will match it closely with appropriate Control panel setup settings and will memorize its settings for future use. Examples are provided in COLORSTREAM Inventory Management.

This MASTER TEMPLATE is the basis for groundwork in the COLORSTREAM Inventory Management methodology.

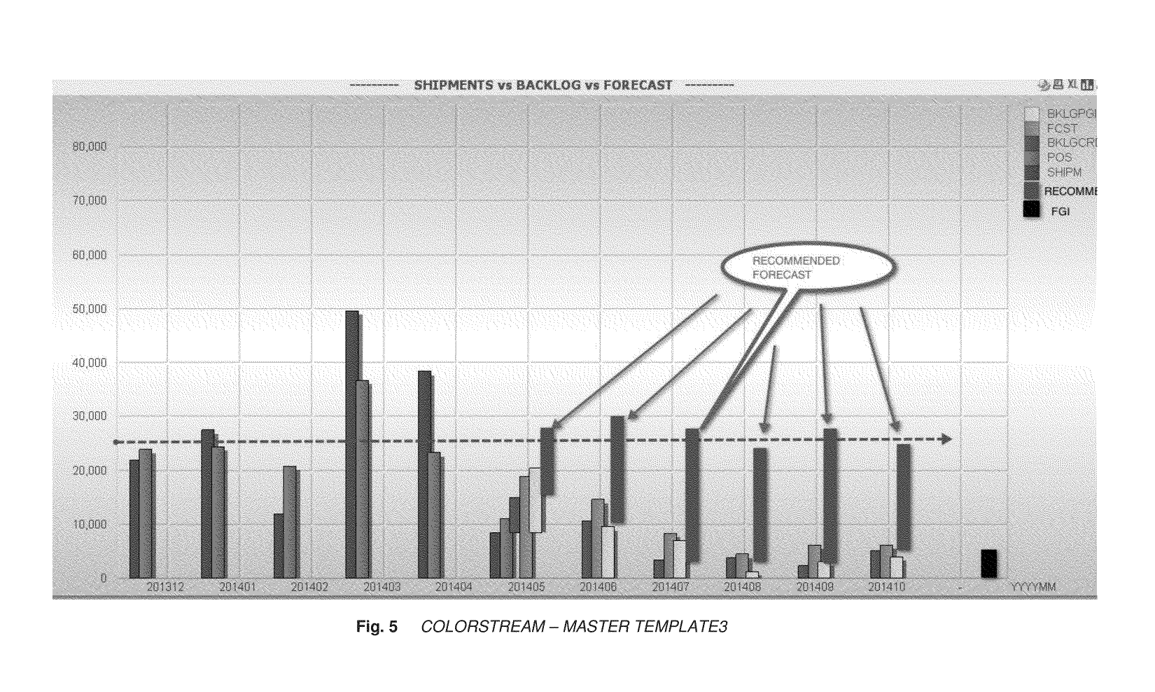

As depicted in FIG. 5, the MASTER TEMPLATE framework can be setup in Monthly, Weekly or even Daily time frame “buckets” depending on customer cycle times and desired windows of visibility and calculation.

The CONFIGURATION MANAGER installed in the DASHBOARDSTREAM system is a web based Graphical User Interface and proprietary software system for defining specific parameters in the system calculations used to derive a final number that is the RECOMMENDED FORECAST as is illustrated in purple in the MASTER TEMPLATE3 depicted in FIG. 5.

The CONFIGURATION MANAGER is incorporated into the web page interface of the DASHBOARDSTREAM system and methodology described in my previously mentioned co-pending U.S. patent application.

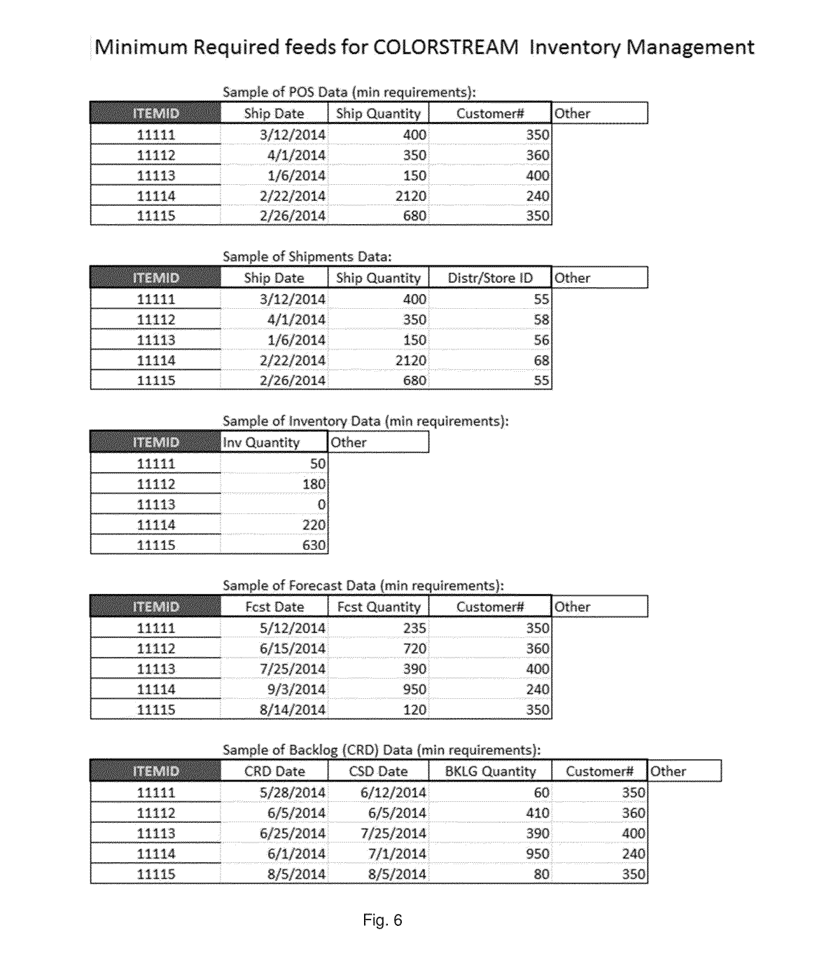

The minimum data requirements for feeds and extracts required from the Customer to support the COLORSTREAM Inventory Management System are shown in FIG. 6 of the Drawing. Additional data (Shipments break down) is not necessary but is helpful.

Shipment data may be be reported in two forms:
1) POS (point of Sale), which are shipments to the final end customer; and
2) Biilings, which are shipments to a Distributor or Store.

The BASE (RUNRATE) (the purple horizontal dashed line) is the most important and vital component in the COLORSTREAM methodology, and is used as a reference for all computations. It is a calculated number, represented graphically in the graphs of FIGS. 4 and 5. It is derived from the statistical historical data and existing backlog layouts. It is constructed using one average, or a combination of weighted averages. The BASE is configurable and can be calculated as desired by an end Customer using median, mean, exponential or weighted averages of historical POS (Shipments), and including (or not) current month backlog. It is very important to establish the BASE by applying a historical average, and the BASE number per se must be reported to the COLORSTREAM system. The BASE number (quantity of units) is the ONLY number required by the system in order to drive the calculated final RECOMMENDATIONS.

The BASE is used to establish patterns and run analytical computations against its level.

The BASE is established to serve as a starting point for the set of analyses to be applied for calculations to be made in the predictive and /or prescriptive analysis.

The CURRENT MONTH (or current time frame bucket) in the COLORSTREAM system template is always in the middle of the chart.

As depicted in FIG. 5, the CURRENT Month Backlog (the red bar) is offset vertically by the MTD (month-to-date) Shipped quantity (Blue Bar).

The BASE value is used as a basis for further analysis and is considered to be equal to 100%, or 1.00 unit, and serves as the initial level of measurements on the MASTER TEMPLATE for each component of the graph.

All other measurements are calculated from the graph and are represented in comparison to 100% of the BASE (1.00=1 unit of Base).

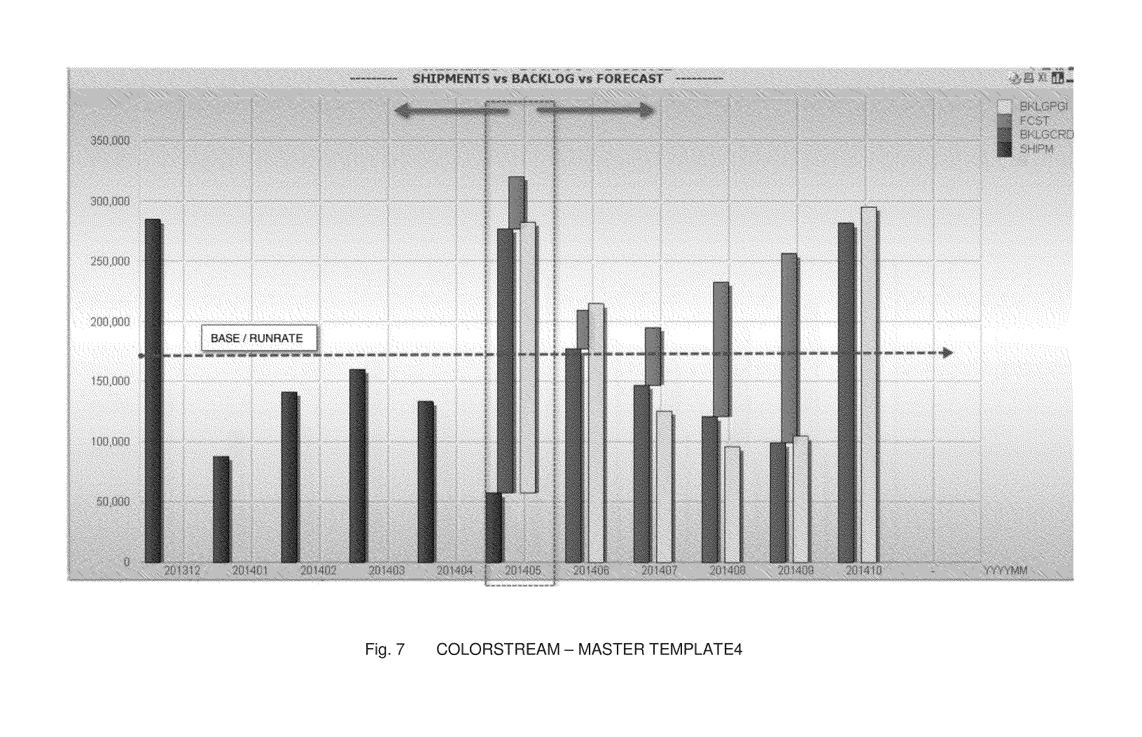

FIG. 7 depicts a “COLORSTREAM—MASTER TEMPLATE4” and illustrates how the SYSTEM sees colors for each dimension and CURRENT MONTH (MAY-2014=201405).

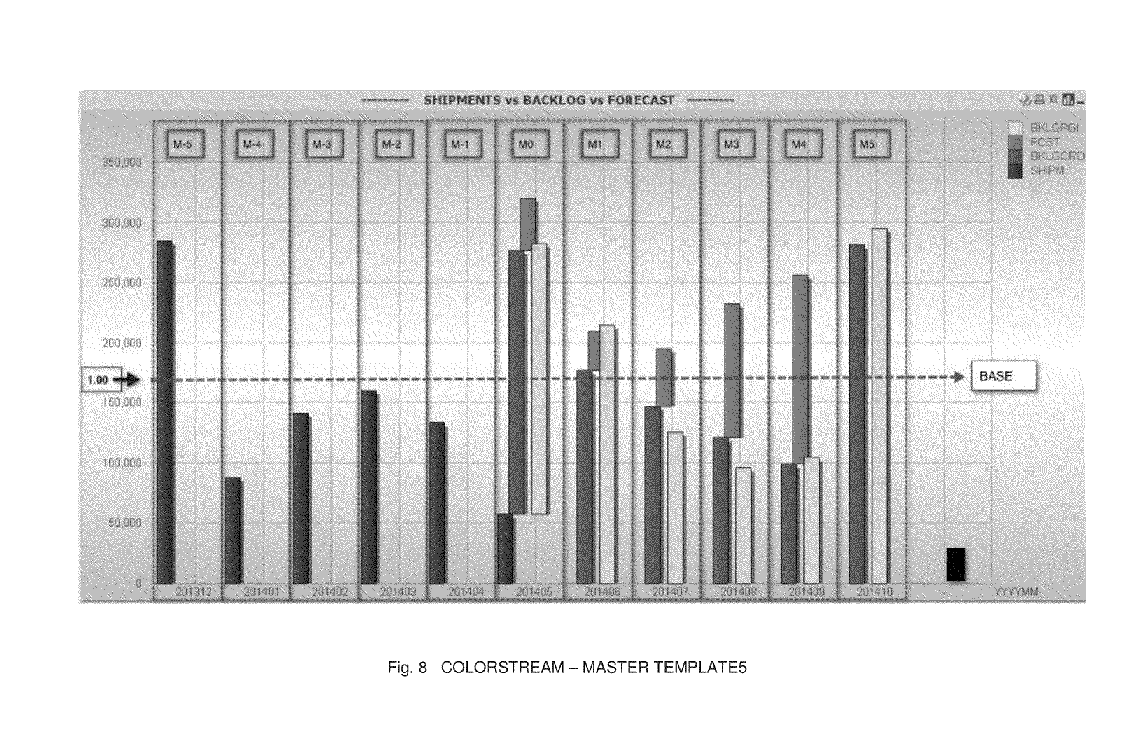

As in the previously described templates and as more clearly shown in FIG. 8, the vertical dimension is in terms of units counted (reported) and the Chart area is divided into equal Time Frame Buckets (M−5)to (M−1) to the left side, and (M+1) to (M+5) to the right side of the Current bucket (MO). In the illustrated case, Monthly buckets are shown and identified at the bottom by a number revealing the year and month (but it could be Daily, Weekly or Quarterly buckets that are used).

The COLORSTREAM Inventory Management System breaks down the graphical image of the Master Template for each time frame into multiple logical areas for analysis and as an aid in readings of the levels for each parameter. This break down is illustrated in FIG. 8 which is designated “MASTER TEMPLATES”.

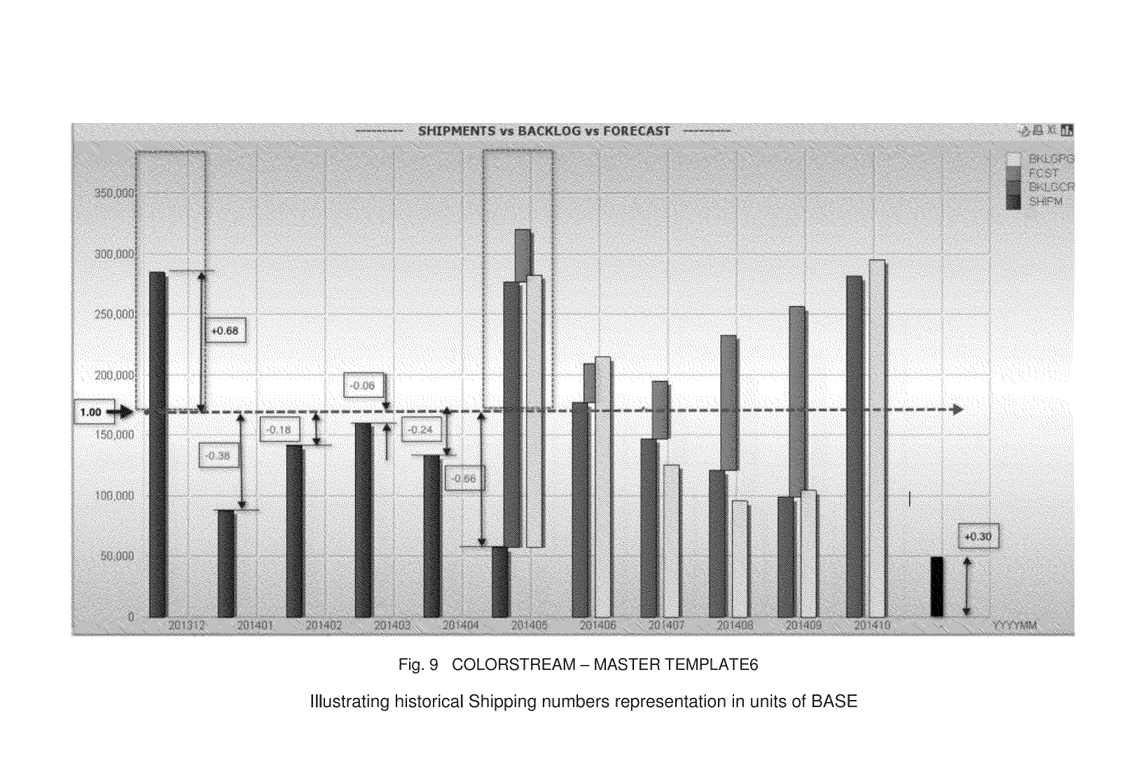

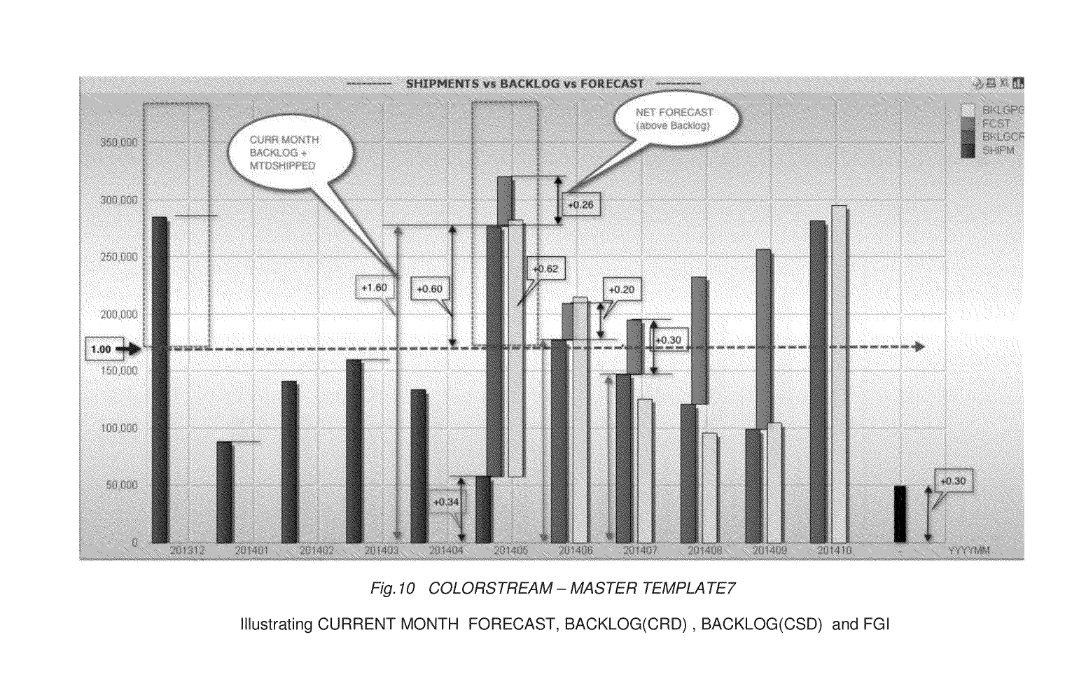

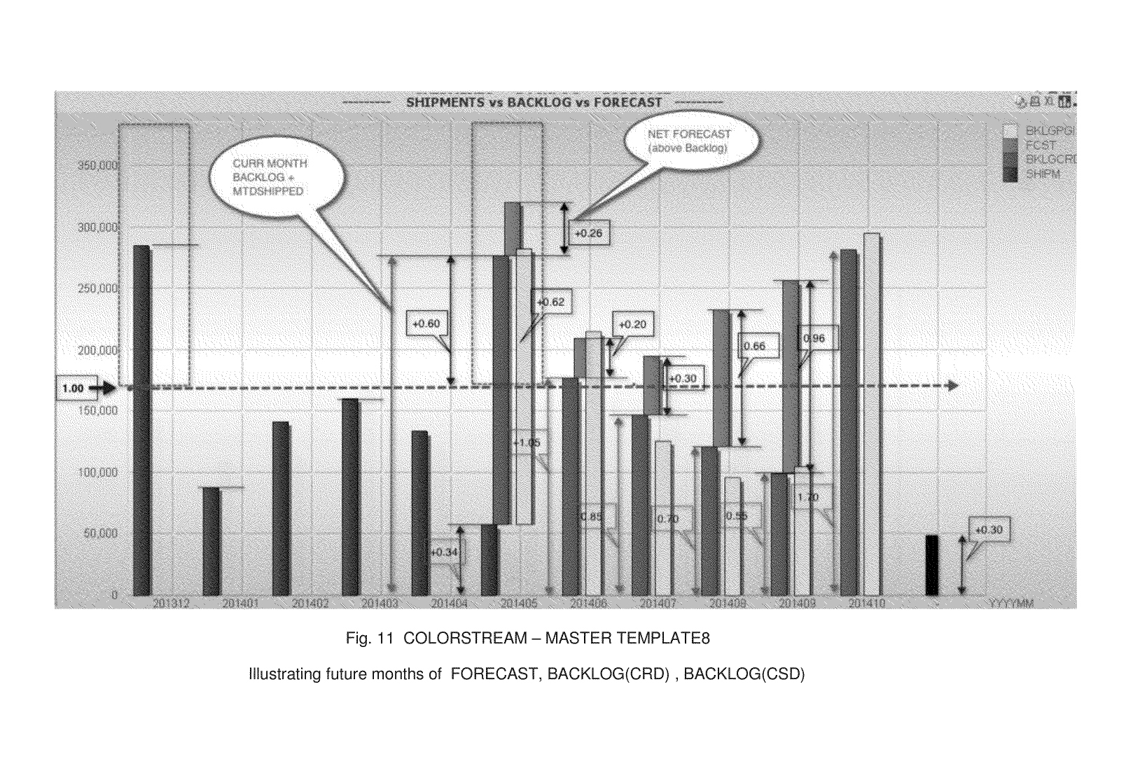

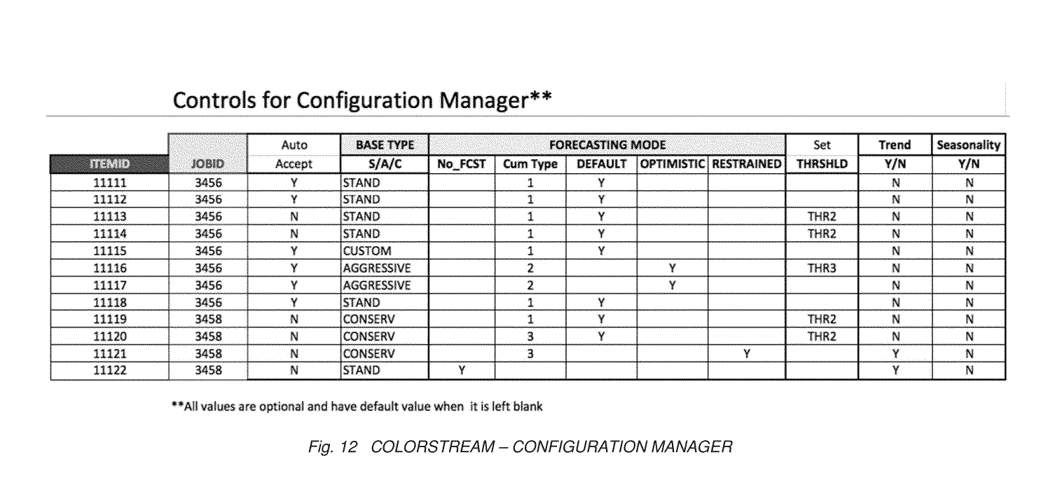

The following drawings designated FIG. 9-“MASTER TEMPLATE6”, FIG. 10—” MASTER TEMPLATE7” and FIG. 11—“MASTER TEMPLATES” illustrate how the system reads each specific component by its reference to the dashed BASE line. Using this comparison to the BASE it is not difficult to recalculate all bars in this graph (chart) for the CURRENT MONTH and all other months on the left (historical sales) and on the right (future sales) of the CURRENT MONTH. Assigning specific relative virtual values (in the units of the BASE) to each explicit component of color-coded bar in the graph, and using them to make calculations is strategically important in the COLORSTREAM Inventory Management methodology.

The following is an example of the assignment of virtual values in the units of the BASE:

All relative virtual values (in the units of the BASE*) are assigned to every distinct colored bar on the graph. See each relative value depicted in FIGS. 9-11, i.e., MASTER TEMPLATEs 6, 7, 8A.
A. The BASE*=171,500 units and represents 100% which equals 1.00, the base unit, *Established on weighted average of Shipments+BACKLOG qualified as described below
B. SHIPPED (for simplicity, herein shown in FIG. 9 as just one bar) in units of BASE

201312→2013-DEC=(1.00+0.68)=1.68

201401→2014-JAN=(1.00−0.38)=0.62

201402→2014-FEB=(1.00−0.18)=0.82

201403→2014-MAR=(1.00−0.06)=0.94

201404→2014-APR=(1.00−0.24)=0.76
C. SHIPPED Month-To-Date (MTDSPD)-the blue bar is -represented as -66% from BASE, so it equals=0.34

201405→2014-MAY (CURR MONTH)=(1.00−0.66)=0.34
D. FGI (the black bar) is represented as=0.30 (units of BASE).
E. BACKLOG CRD (FIG. 4)—represented by the red bars: 201405→2014-MAY=1.26

201406→2014-JUN=1.05

201407→2014-JUL=0.85

201408→2014-AUG=0.70

201409→2014-SEP=0.55

201410→2014-OCT=1.70
F. FORECAST in FIG. 4 and FIG. 5 is represented by the NET value:
1) GROSS FORECAST includes BACKLOG and MTDShipped=1.60+0.28=1.88
2). NET FORECAST is ONLY pure remaining forecast on the top of backlog and MTDSHPD and it is 0.28 (units of BASE)

For the system we will use both—GROSS and NET FOREC

CURRENT MONTH→201405→2014-JUN=1.86 0.26

201406→2014-JUN=1.25 0.20

201407→2014-JUL=1.15 0.30

201408→2014-AUG=1.36 0.66

201409→2014-SEP=1.51 0.96

201410→2014-OCT=1.70 0.00

After all figures and chart data have been setup and valued according to (or dimensioned relative to) the BASE, it is ready for predictive and prescriptive (RECOMMENDATIONS) analysis in the application described herein as the “COLORSTREAM (ColorStream IM*) Inventory Management” system.

After all of the relative virtual values (in reference to the BASE) are calculated by the system, the SYSTEM is ready to operate on its own numbers and there is no need to work on actual data numbers (of Shipments, Backlog, FGI and Forecast). In other words after all values for the above “dimensions” have been “translated” by the system into BASE values. The Graph (bar chart) is used as a template or master for this translation.

This conceptual approach is to simplify management of the underlying numbers and to deal with systematically “translated” values (in relation to the BASE) employing colors in the graph.

It will thereafter be relatively easy to align the data of any Customer using the same MASTER TEMPLATE and data feed to the system, which can then effectively and efficiently produce graphical results.

The final result of the predictive analysis will be a correction to FORECAST (open orders), referred to herein as the RECOMMENDED FORECAST.

Assumptions

There are several important assumptions involved in this methodology:

1) RECOMMENDED FORECAST—is a forecast prediction by default and has a “Neutral stance” whereas any fluctuation in demand represents a deviation from the BASE and has a tendency to come back to neutral stance—i.e. to its BASE.

2) BASE a chart level created using a calculated average based on shipping history and/or backlog together, and it can be more or less aggressive depending on customer preferred configuration settings: e.g., simple, exponential, weighted etc., in different time frames. Examples might be classified as:
a. STANDARD (Neutral) BASE type;
b. AGGRESSIVE type; or
c. CONSERVATIVE type.

3) The BASE value is always=1.00 (100%)

4) Multiple FORECASTING MODES are used in the COLORSTREAM system to align with user (Customer) business strategy in thriving vs. weakening conditions, or stable vs. unstable states. Forecasting modes will use differ calculation modes providing a gradient as to its level of confidence:
a. DEFAULT Forecasting Mode
b. OPTIMISTIC Mode
c. RESTRAINED Mode
d. No Fcst

5) Trends and seasonality considerations will be respected if the Customer so chooses.

6) If TREND is chosen—specific Customer defined base points will be added in months subsequent to the BASE during RECOMMEDED FORECAST calculations.

7) A System user (Customer) will provide at set-up, an indication as to how the system should react in a multi-set of scenarios provided. If scenarios are not provided, a default setup will be used.

8) CURRENT MONTH—is a 4 or 5 week month and each calculated RECOMMENDATION will be proportionally reduced by the amount of time (in weeks) left in the CURRENT MONTH.

9) A monthly fiscal Calendar of 4/4/5 weeks is used to fix each month at a specific number of weeks to facilitate comparisons from month to month and year to year.

The BASE will be adjusted based on 4-4-5 week in the fiscal calendar month
a. 4-week month=BASE*0.93
b. 5-week month=BASE*1.15

Controls of Threshold, Base, Forecast Mode, Trends and Seasonality:

Configuration Manager
Details of each parameter in the Operations Manager are described in an associated subsection below:
Thresholds
Base Modes
Forecasting Types
Trends
Seasonality

Base Types

Depending on the business situation and/or customer preference there are different BASE Types that are used in this methodology. Three major distinctive BASE types are:
1) STANDARD;
2) AGGRESSIVE; and
3) CONSERVATIVE.

It is important to pick a specific BASE type on a detailed level in the CONFIGURATION MANAGER in accordance with existing business conditions, situations and Customer judgment.

In the CONFIGURATION MANAGER the BASE type can be setup on an Item level.

Each type will have a different impact on the calculated final recommendations produced by the COLORSTREAM system. Each BASE type reflects a different BASE level in calculations, which subsequently will impact RECOMMENDED FORECAST levels.

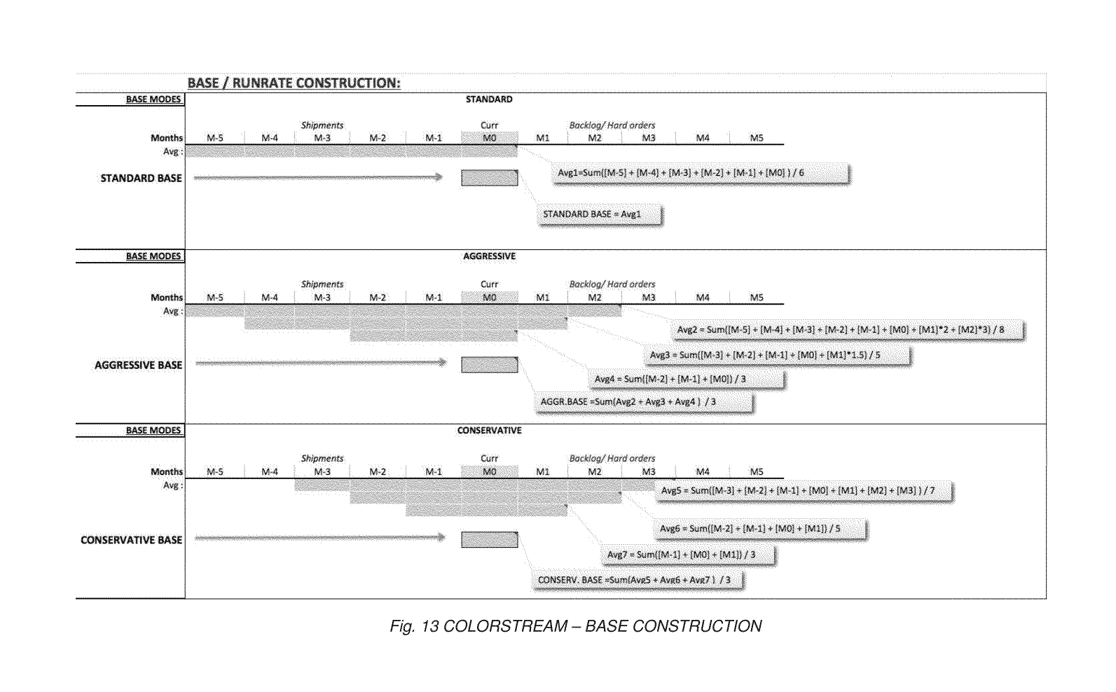

BASE=STANDARD TYPE is selected by default unless it is overridden by the User. It is a calculated number or average where only past historical data is used. As illustrated in FIG. 13, the BASE types are determined as follows:

STANDARD BASE=Avg1=Sum ([M−5]+[M−4]+[M−3]+[M−2]+[M−1]+[M0])/6

AGGRESSIVE BASE is more weighted to most current data with emphasis on hard backlog. It reacts more aggressively to spikes and declines in demand in assuming its uptrend or downtrend by establishing lower or higher BASE and pulling RECOMMENDED forecast with it.

The AGGRESSIVE BASE is calculated as follows:

Avg2=Sum ([M−5]+[M−4]+[M−3]+[M−2]+[M−1]+[M0]+[M1])*2+[M3]*3)/8;

Avg3=Sum ([M−3]+[M−2]+[M−1]+[M0]+[M11])/5;

Avg4=Sum ([M−2]+[M−1]+[M0])/3; and

AGGR BASE=Sum (Avg2+Avg3+Avg4)/3.

CONSERVATIVE BASE is used for focusing on hard backlog and shorter calculation windows. It reacts less aggressively to peaks in demand and stays on lower end of calculated BASE value.

The CONSERVATIVE BASE is calculated as follows:

Avg5=Sum ([M−3]+[M−2]+[M−1]+[M0]+[M1]) +[M2]+[M3])/7;

Avg6=Sum ([M−2]+[M−1]+[M0]+[M1])/5

Avg6=Sum ([M−1]+[M0]+[M1])/5; and

CONSERV BASE=Sum (Avg5+Avg6+Avg7)/3.

There are many variations of each BASE construction that can be used depending on the Customer's desire.

The Formulas for BASE construction are thus configurable by the Customer and are a part of the Configuration controls provided to the Customer.

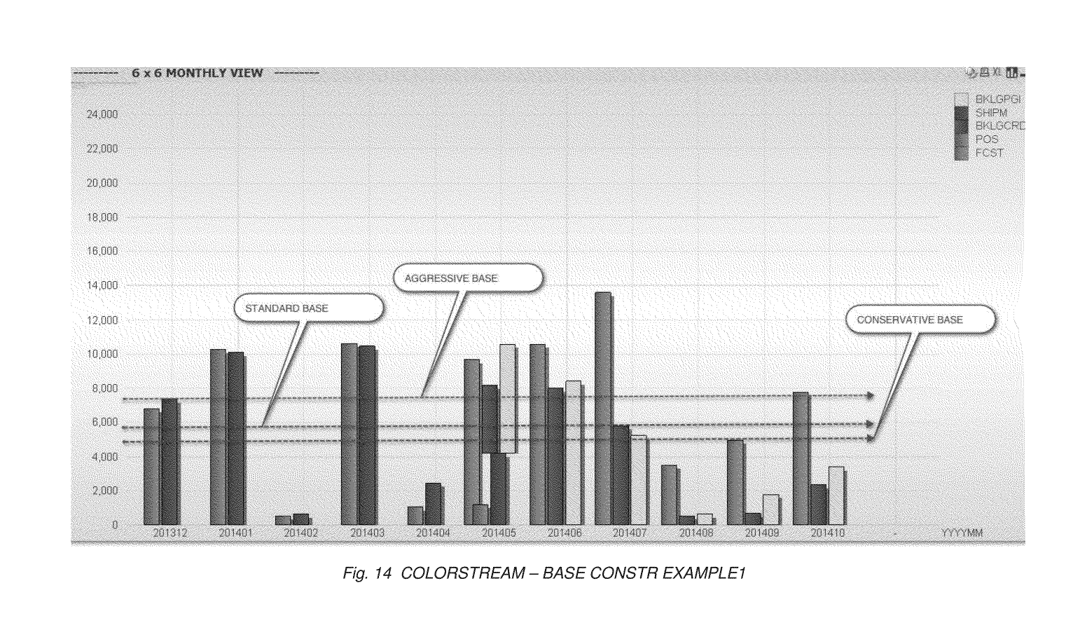

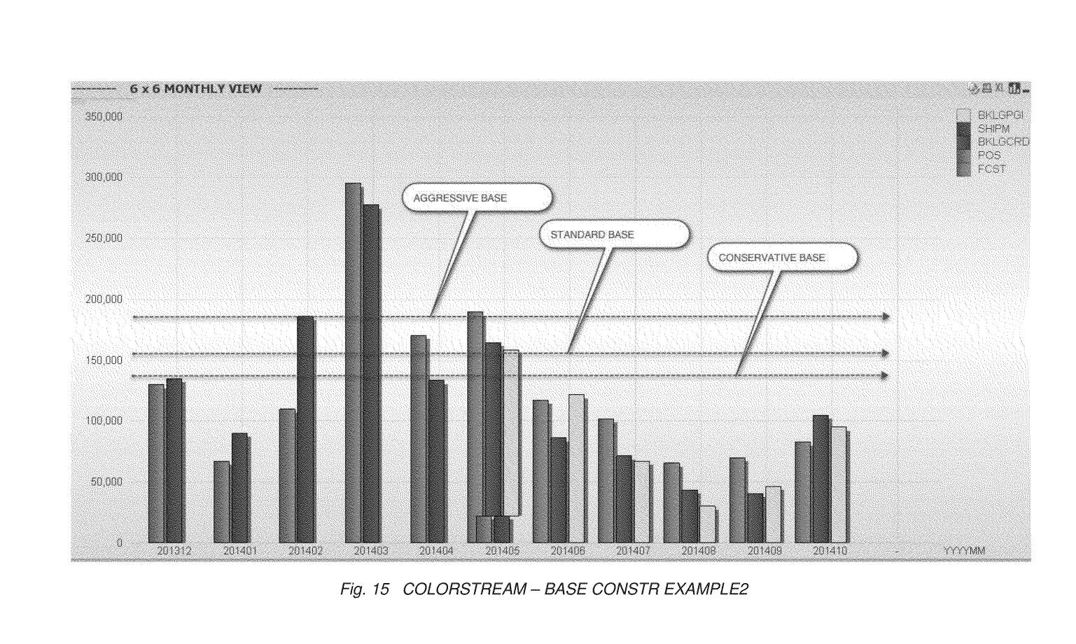

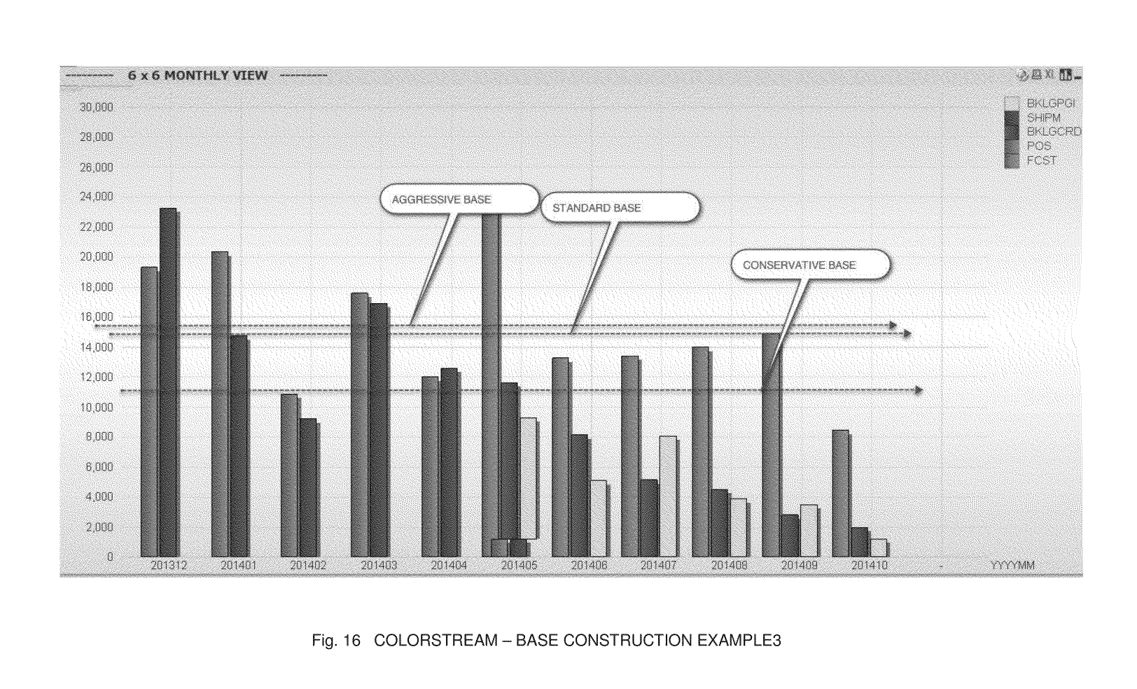

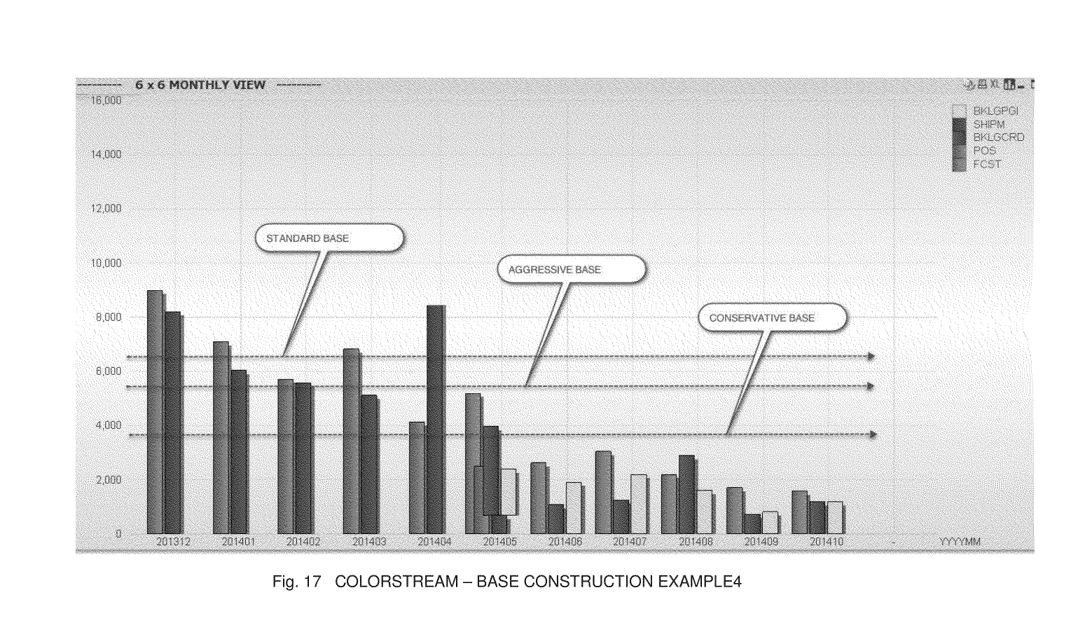

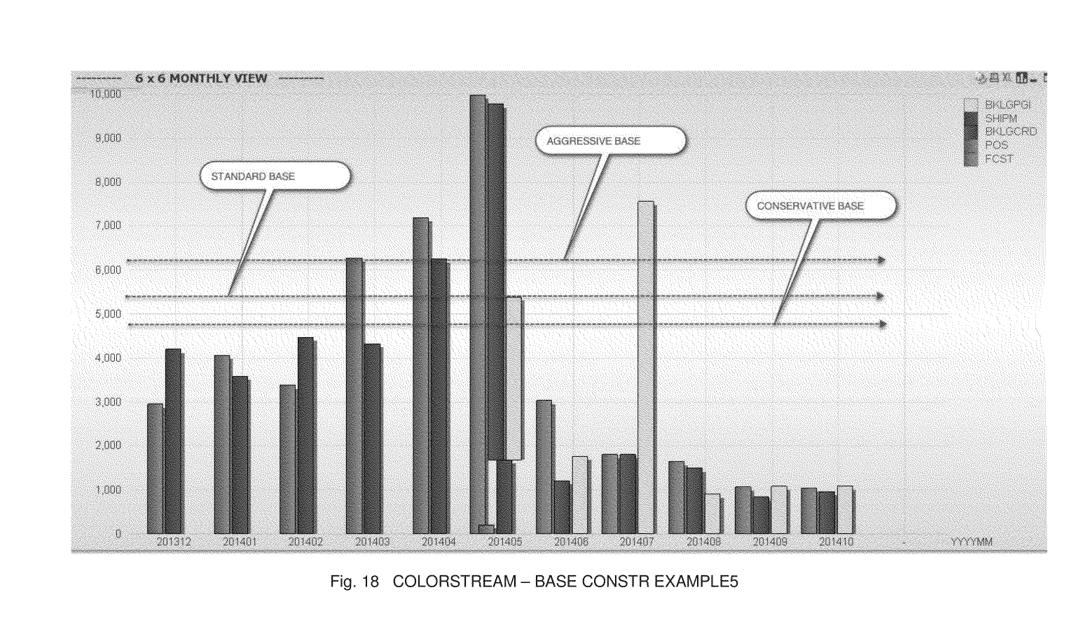

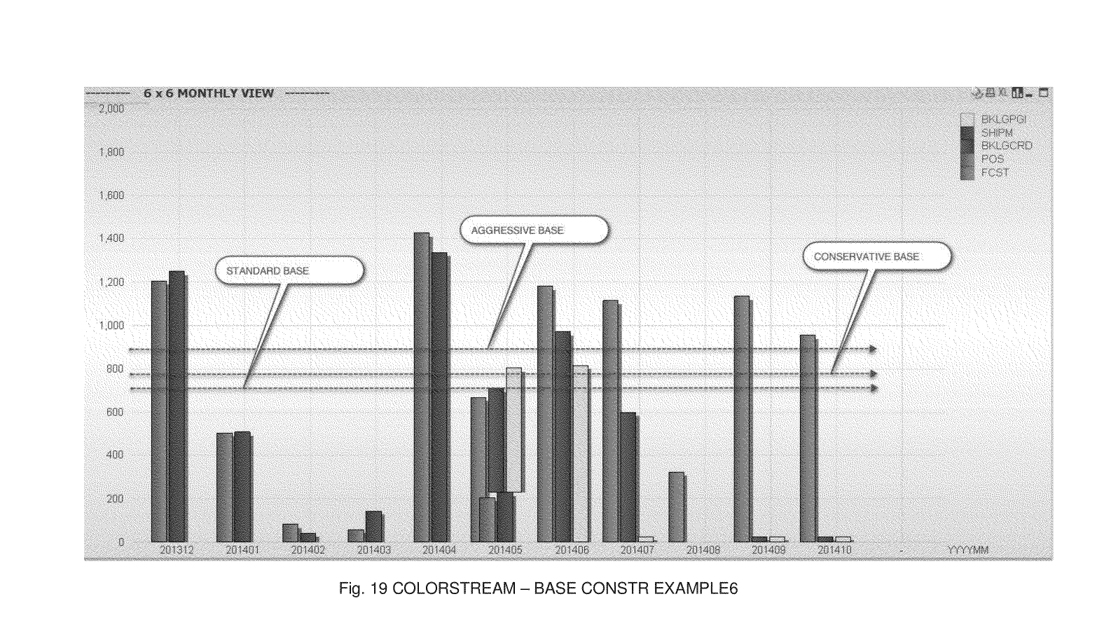

FIGS. 14-19 are illustrations where different Base construction is used, and provide good visible examples of how the selected levels will impact the final Recommendations.

FORECASTING MODES: Forecast here is implied to Time-Series Model of Quantitative method.

The FORECASTING method is a Quantitative, Time Series Model.

DESIRED FORECAST method: RESPONSIVE

(Time series models look at past patterns of data and attempt to predict the future based upon the underlying patterns contained within those data.)

This model utilizes AVERAGE and TRENDs, cycles and random variations. STABILITY VS. RESPONSIVENESS IN FORECASTING

All demand forecasting methods vary in the degree to which they emphasize recent demand changes when making a forecast. Forecasting methods that react very strongly (or quickly) to demand changes are said to be responsive. Forecasting methods that do not react quickly to demand changes are said to be stable. One of the critical issues in selecting the appropriate forecasting method hinges on the question of stability versus responsiveness. How much stability or how much responsiveness one should employ is a function of how the historical demand has been fluctuating. If demand has been showing a steady pattern of increase (or decrease), then more responsiveness is desirable, for we would like to react quickly to those demand increases (or decreases) when we make our next forecast. On the other hand, if demand has been fluctuating upward and downward, then more stability is desirable, because we do not want to “over react” to those up and down fluctuations in demand.

Depending on the business situation and/or Customer preference there are different FORECASTING MODE types that are used in this methodology. Following are 3 major distinctive types:
1) Default (NEUTRAL);
2) Optimistic; and
3) Restrained.

It is important that a specific FORECASTING MODE be selected on a detailed level in the CONFIGURATION MANAGER in accordance with the existing business conditions, situations and Customer's judgment.

In the CONFIGURATION MANAGER the MODE can be set-up on an Item level.

DEFAULT MODE REVIEW:

Example 1 (DEFAULT):

In the DEFAULT mode if BACKLOG+MTDSHIP>BASE then just a small percentage is added to the first 3 buckets—M0, M1, M2. For the same condition, nothing is added to M3, M4, M5.

This percentage can be fixed to the same number or broken down in different %% number (units of BASE) for each month.

The following is a control table for DEFAULT mode correction:

| | DEFAULT | | | | | |
|---|---|---|---|---|---|---|
| | M 0 | M 1 | M 2 | M 3 | M 4 | M 5 |
| % if BKLG > | 0.16 | 0.12 | 0.12 | 0 | 0 | 0 |
| BASE | | | | | | |
| % if BKLG < | −0.32 | −0.12 | 0 | | | |
| BASE** | | | | | | |

**Reduction of BASE in this situation works in reverse order

BACKLOG+MPDSHIP

M0(CURRENT MONTH)−201405→2014-MAY=1.26+0.34=1.60
BASE=171,500 units=1.00
If today is May 5 for instance—by interpolating remaining time in May+0.12 uob

If BKLG<BASE, interpolation works in reverse order. I.e. for May 5 it would be -0.08 and by end of May it would be at its full value−0.32

M0 RECOMMENDED NET FORECAST=0.12

GROSS FORECAST=1.72

M1 (2014-JUN)−201406→BACKLOG =1.05

BASE=171,500 units=1.00
If today is May 5 for instance−by interpolating the remaining time in May+0.12 uob

M1 RECOMMENDED NET FORECAST=0.12
GROSS FORECAST=1.17

M2 (2014-JUL)−201407→BACKLOG=0.85

BASE=1.00

M2 is JULY−it is 5-week month, so BASE*1.15 (vs. 4-week month=BASE*0.92)

M2 RECOMMENDED NET FORECAST=(1.15−0.85)=0.30

GROSS FORECAST=1.15

M3 (2014-AUG)−201408→BACKLOG=0.70

M3 is AUG−it is 4-week month, so BASE*0.92=0.92

M3 RECOMMENDED NET FORECAST=(92−70)=0.22

GROSS FORECAST=0.92

M4 (2014-SEP)−201409→BACKLOG=0.55

BASE=1.00

M3 is AUG−it is 4-week month, so BASE*0.92=0.92

M4 RECOMMENDED NET FORECAST=(92−55)=0.37
GROSS FORECAST=0.92

Ending results compared to original forecast:

| NET | M 0 | M 1 | M 2 | M 3 | M 4 | M 5 | TOT |
|---|---|---|---|---|---|---|---|
| CURR FORECAST | 0.26 | 0.2 | 0.3 | 0.66 | 0.96 | 0 | 2.38 |
| RECOMMENDED | 0.12 | 0.12 | 0.3 | 0.22 | 0.37 | 0 | 1.13 |
| FCST | | | | | | | |

| GROSS | M 0 | M 1 | M 2 | M 3 | M 4 | M 5 | TOT |
|---|---|---|---|---|---|---|---|
| CURR FORECAST | 1.86 | 1.25 | 1.15 | 1.36 | 1.51 | 0 | 7.13 |
| RECOMMENDED | 1.72 | 1.17 | 1.15 | 0.92 | 0.92 | 0 | 5.88 |
| FCST | | | | | | | |

Overall recommended forecast showing reduced quantity compared to original forecast by more than a double (NET).

The Final step is to convert RECOMMENDED FCST relative value into actual numbers to override the original forecast:

Example 1.

| | M 0 | M 1 | M 2 | M 3 | M 4 | M 5 | TOT |
|---|---|---|---|---|---|---|---|
| ORIG GROSS | 1.86 | 1.25 | 1.15 | 1.36 | 1.51 | 0 | 7.13 |
| FORECAST | | | | | | | |
| RECOMMENDED | 1.72 | 1.17 | 1.15 | 0.92 | 0.92 | 0 | 5.88 |
| FCST (base units) | | | | | | | |
| BASE: | 171,500 | 171,500 | 171,500 | 171,500 | 171,500 | 171,500 | 1,029,000 |
| RECOMM FCST | 294,980 | 200,655 | 197,225 | 157,780 | 157,780 | 0 | 1,008,420 |
| values: | | | | | | | |

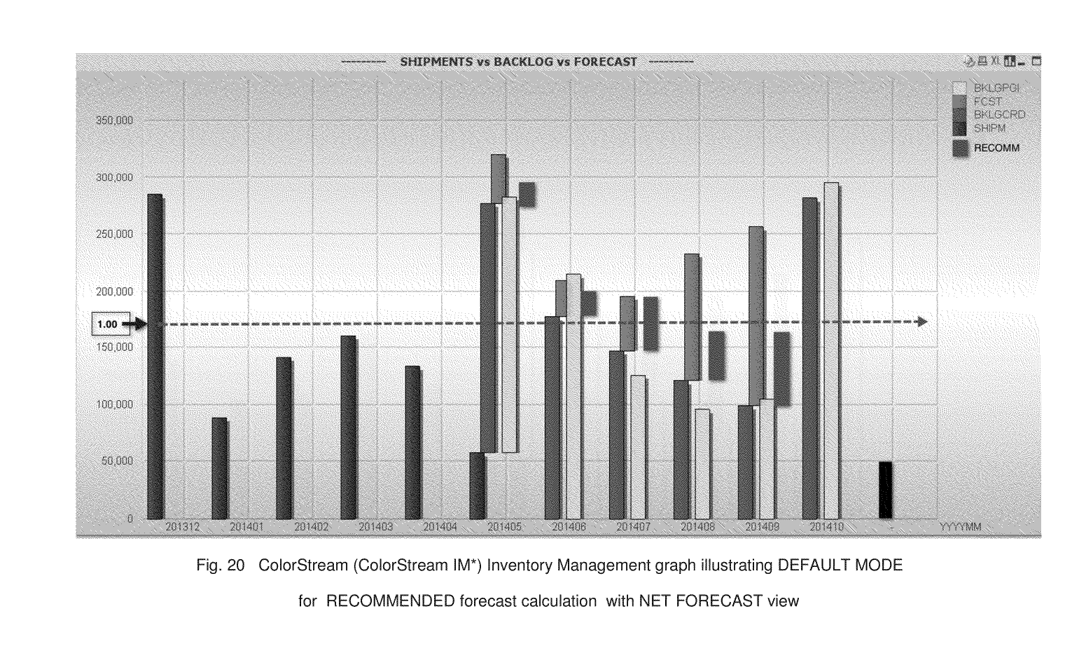

FIG. 20 illustrates the above in a graph including NET and GROSS FCST views:

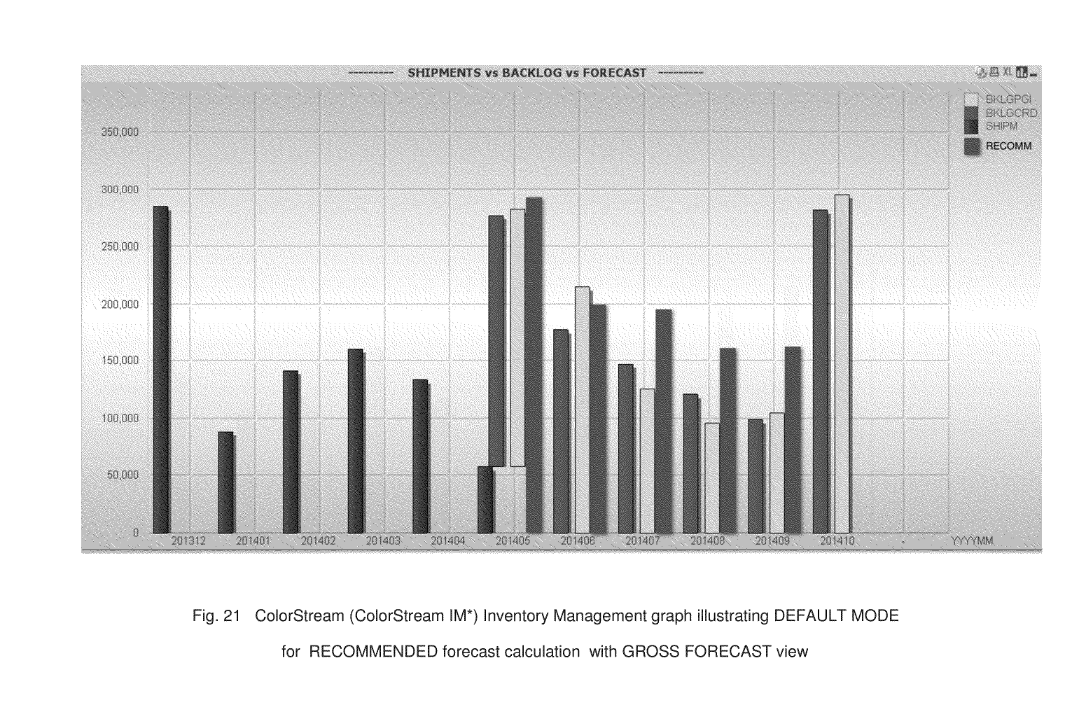

FIG. 21 is an Inventory Management graph illustrating the DEFAULT MODE for the RECOMMENDED forecast calculation with the GROSS FORCAST view.

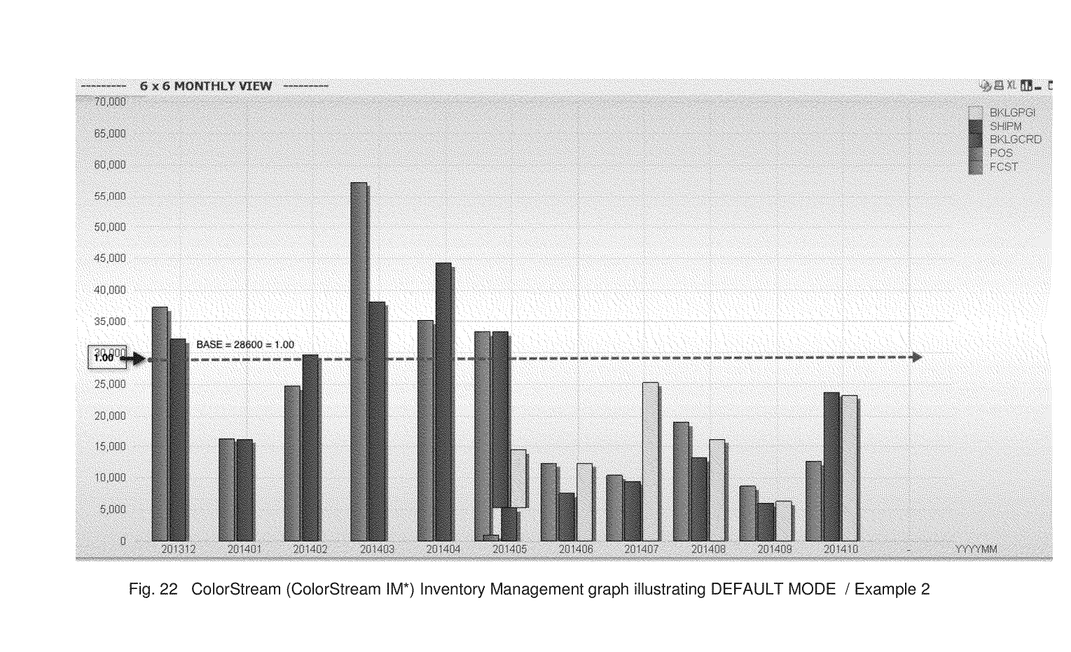

FIG. 22 shows another example illustrating the DEFAULT MODE : historical shipment data representing a stable RUNRATE.

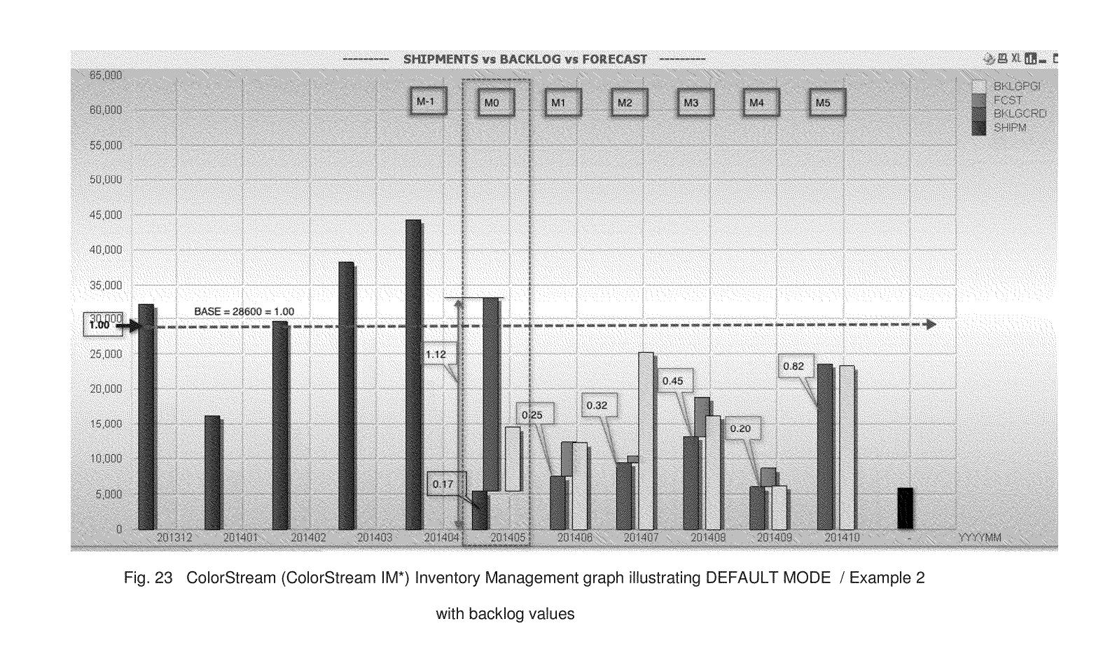

FIG. 23 is another example of an Inventory Management graph illustrating the DEFAULT MODE with backlog values.

In the Restrained Forecasting Mode it follows downtrend with little or no return to neutral state.

In the No_FCST mode, any forecast will be eliminated and Item/Group will only use hard orders—BACKLOG.

TREND (Y/N)—is used to recognize historical trend and slant the RECOMMANDED forecast in the direction of the trend.

SEASONALITY (Y/N)—is used to recognize comparison of seasonally aggregate time frame buckets of historical data and apply additional seasonal coefficient.

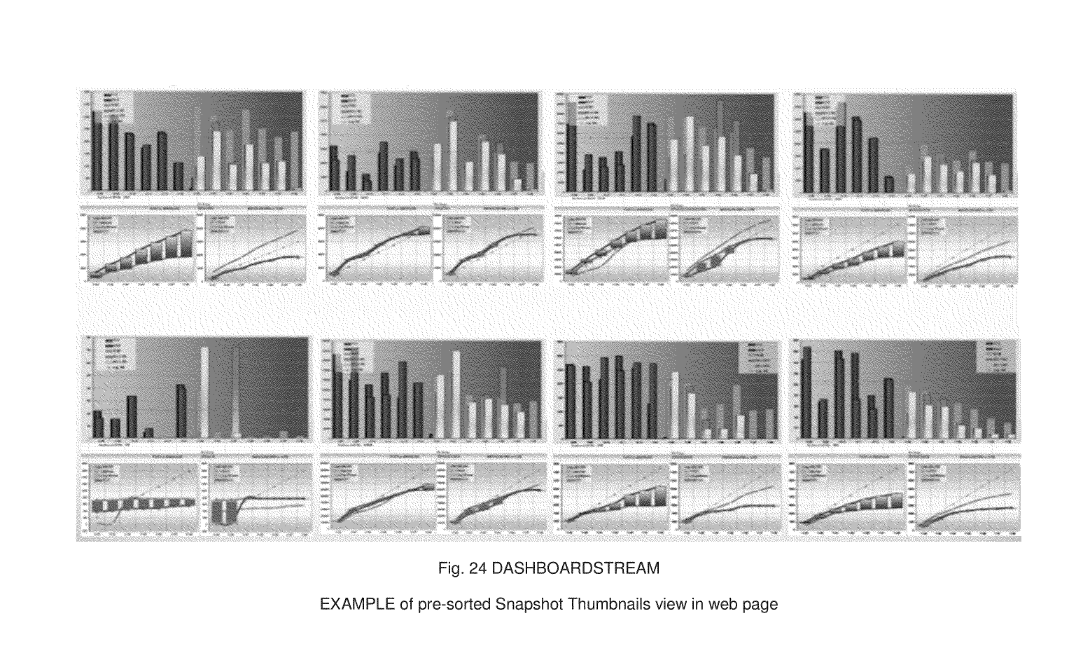

FIG. 24 is an example of Snapshot thumbnails for a BI dashboard built for an Inventory Management System.

There are 8 thumbnail views in this example. Thumbnails in this example show only graphical image of inventory state including monthly view of historical shipments and current orders plus forecast.

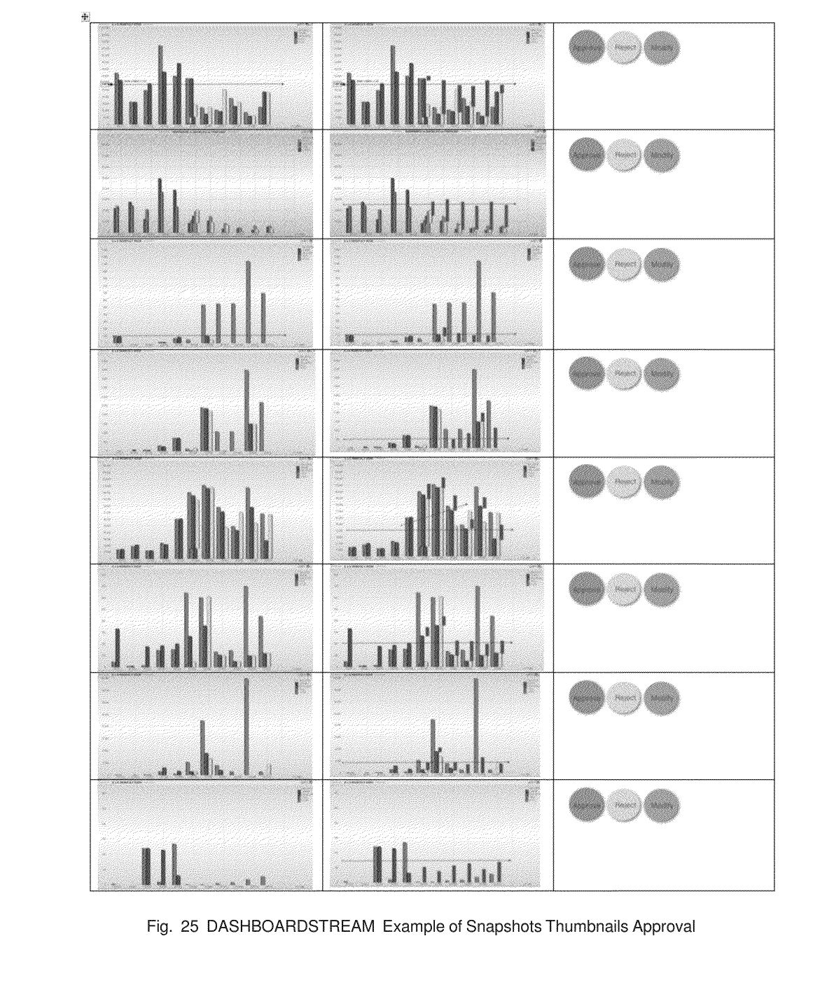

FIG. 25 is an Illustration of Approval flow.

On the personal Customer web page buttons will be provided next to each thumbnail for “Approve”, “Reject” or “Modify” action.

The DASHBOARDSTREAM System will act according to the Customer's decision:

If “Approve” is picked, then the system will process recommendations for particular items to make forecast adjustments in the system.

It will be a systematic process aligned and agreed with the Customer.

If the Customer chooses “Reject”—this items recommendations will be discarded and a log will be created.

The next time DASHBOARDSTREAM will respect the decision and keep in memory the user's (Customer's) selection, and will keep this item outside of the automated processing.

If the user chooses “Modify”—the system will allow intervention and manual modification of the recommendations.

The preceding description provides only exemplary embodiments of the present invention, and such embodiments are not intended to limit the scope, applicability, or configuration of the invention. Rather, the description of the several embodiments is intended to provide those skilled in the art with an enabling description for implementing an embodiment of the invention. It is therefore to be understood that various changes may be made in the function and arrangement of the disclosed components, elements and embodiments without departing from the true spirit and scope of the invention set forth in the appended claims.

1. An Inventory Management system and methodology constructed on employing a BASE association algorithm in assessment of graphical images for Inventory or Safety Stock/Forecast/Supply and/or Purchase Order management and engaging procedure designed for systematic calculation of inventory adjustments based on graphical components interpretation and user defined rules, comprising:
working with associative numbers assigned to each component in every time bucket of graphical chart in reference to its distinct BASE or calculated RUNRATE; and
assigning explicit colors to each component using color recognition in establishing the associations by measuring and comparing its levels in each defined area of the chart.

2. An Inventory Management system and methodology as recited in claim 1 wherein a straight calculation is used to determine associative levels of components.

3. An Inventory Management system and method for prescriptive analysis of forecast, demand modeling and material requirements planning (MRP) for production planning and inventory control in managing manufacturing processes, comprising:
expressing levels for every component in units of established BASE in every time frame bucket of a chart to provide a foundation for computation of recommended forecast adjustments; and
inspecting and evaluating current inventory and forecast (future open orders), Shipping history and current Backlog (hard orders) on at least a daily basis to address active supply/forecast management and to control inventory levels.

4. An Inventory Management system and method as recited in claim 3 and further comprising:
using an automated process of future inventory corrections in form of recommended adjustments to control its outcome by employing configuration controls, visualizing its output on very detailed level in form of snapshots and providing a final semi-automated approval step with override capability.

5. An Inventory Management system and methodology including employing a BASE association algorithm in assessment of graphical images for an Inventory or Safety Stock / Forecast/Supply and/or Purchase Order management and engaging procedure designed for systematic calculation of inventory adjustments based on graphical components interpretation and user defined rules, comprising:
utilizing a bar chart master template having a plurality of fixed time period buckets for containing one or more color coded vertical component bars the heights of which correspond to various categories of counts of item data accounted for or estimated during each time period, the time period buckets being organized to include a current time period bucket preceded in time scale by a predetermined number of time-wise concatenated previous time period buckets and succeeded in time scale by said predetermined number of time-wise concatenated future time period buckets;
receiving input data feeds of business related factors including
a) Shipments (historical data);
b) Backlog (Open orders);
c) Inventory (FGI—finished goods); and
d) Forecast (Future open orders);
time-wise populating each of said buckets with component bars representing quantitative counts of items corresponding to said factors included in said data feeds;
calculating a base line/runrate determined by an averaging of the data counts of items included in all of said buckets;
normalizing the actual counts represented by the bars in each said bucket relative to said base/rate to develop associative numbers for each said component bar;
working with said associative numbers assigned to each said component bar in every time bucket of said chart in reference to said calculated base/runrate; and assigning different explicit colors to each said component bar using color recognition to establish the associations by measuring and comparing the levels in each defined bucket area of the chart.

6. An Inventory Management system and methodology as recited in claim 5 wherein a straight calculation is used to determine associative levels of said component bars.
